(19) United States
(12) Patent Application Publication
(10) Pub. No.: US 2018/0364936 A1
(43) Pub. Date: Dec. 20, 2018

(54) STORAGE CONTROL DEVICE, METHOD AND NON-TRANSITORY COMPUTER-READABLE STORAGE MEDIUM

(71) Applicant: FUJITSU LIMITED, Kawasaki-shi (JP)

(72) Inventor: So KIJIMA, Kawasaki (JP)

(73) Assignee: FUJITSU LIMITED, Kawasaki-shi (JP)

(21) Appl. No.: 16/005,737

(22) Filed: Jun. 12, 2018

(30) Foreign Application Priority Data
Jun. 20, 2017 (JP) 2017-120360

(51) Int. Cl. G06F 3/06; G06F 11/20

(52) U.S. Cl. CPC G06F 3/0635; G06F 11/2005; G06F 11/201; G06F 3/0689; G06F 3/0614; G06F 3/067; G06F 3/0665

(57) ABSTRACT

A storage control device is configured to, when a communication error is detected in an accessing to the storage device, store error detection information, receive an access request to a first virtual volume, access the first virtual volume via a first access path as the specific path, when a communication error is detected in an accessing to the first virtual volume, access the first virtual volume using a second access path, generate a plurality of virtual volume groups from a plurality of virtual volumes of the storage device, based on the error detection information, select a first virtual volume group from the plurality of virtual volume groups, and switch the specific path for a second virtual volume in which no communication error is detected and which is included in the first virtual volume group.

### CROSS-REFERENCE TO RELATED APPLICATION

This application is based upon and claims the benefit of priority of the prior Japanese Patent Application No. 2017-120360, filed on Jun. 20, 2017, the entire contents of which are incorporated herein by reference.

### FIELD

The embodiments discussed herein are related to a storage control device, a method and a non-transitory computer-readable storage medium.

### BACKGROUND

A virtual volume is a virtual memory area that is implemented by a physical memory area included in a memory device. In storage systems, generating a virtual volume as appropriate and accepting an access request from a host device with respect to the generated virtual volume enable an efficient use of a physical memory area.

The physical memory area corresponding to a virtual volume may be implemented in a memory device externally coupled to a control device that accepts an access request to the virtual volume. In this case, upon accepting an access request to a virtual volume, the control device accesses the memory device, and executes an input/output (IO) process with respect to the physical memory area corresponding to the virtual volume.

Moreover, the configuration in which the memory device is externally coupled to the control device enables the redundancy of the access path between the control device and the memory device. As an example of such configuration, proposed is a storage system in which priorities are assigned to a plurality of access paths, and when a fault occurs in the access path being used, an access path with a second highest priority is selected. Examples of the related art include Japanese Laid-open Patent Publication No. 2006-178811.

### SUMMARY

According to an aspect of the invention, a storage control device configured to access a storage device via a plurality of access paths, a plurality of virtual volumes being formed using the storage device, the storage control device includes a memory configured to store setting information on each of the plurality of virtual volumes, the setting information including respective setting values of a plurality of setting items, the plurality of setting items including a path setting item that identifies a specific path included in the plurality of access paths used when the storage control device accesses the storage device, and a processor coupled to the memory and configured to when a communication error is detected in an accessing from the storage control device to the storage device, store error detection information indicating that the communication error is detected in the accessing, receive an access request to a first virtual volume included in the plurality of virtual volumes, in response to the access request, access the first virtual volume via a first access path as the specific path identified based on the setting values of the path setting items, when a communication error is detected in an accessing to the first virtual volume, access the first virtual volume by using a second access path included in the plurality of access paths, based on the setting information, generate a plurality of virtual volume groups from the plurality of virtual volumes, based on the error detection information, select a first virtual volume group from the plurality of virtual volume groups, the setting values of a plurality of virtual volumes included in the first virtual volume group having certain relationship to the setting items of the first virtual volume, and modify the specific path for a second virtual volume in which no communication error is detected and which is included in the first virtual volume group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example and a process example of a storage system according to a first embodiment.

FIG. 2 is a diagram illustrating a configuration example of a storage system according to a second embodiment.

FIG. 3 is a diagram illustrating a hardware configuration example of a CM.

FIG. 4 is a diagram illustrating a configuration example of virtual volumes, RAID groups, and access paths.

FIG. 5 is a block diagram illustrating a configuration example of a processing function included in the CM.

FIG. 6 is a sequence diagram indicating a comparative example of a process procedure when an access to a given virtual volume is requested.

FIG. 7 is a diagram illustrating a data configuration example of a volume management table.

FIG. 8 is a flowchart (Part 1) illustrating an example of IO control processing of a virtual volume.

FIG. 9 is a flowchart (Part 2) illustrating the example of the IO control processing of the virtual volume.

FIG. 10 is a flowchart illustrating an example of preliminary path switching processing corresponding to the time when an error due to the route abnormality is detected.

FIG. 11 is a flowchart (Part 1) illustrating an example of preliminary path switching processing corresponding to the time when an error due to the volume abnormality is detected.

FIG. 12 is a flowchart (Part 2) illustrating the example of the preliminary path switching processing corresponding to the time when an error due to the volume abnormality is detected.

FIG. 13 is a diagram illustrating an example of a case where the path switching is performed with respect to virtual volumes that belong to the same RAID group.

FIG. 14 is a diagram illustrating an example of a case where the path switching is performed with respect to virtual volumes that use the same counterpart port.

FIG. 15 is a diagram illustrating an example of a case where the path switching is performed with respect to virtual volumes that use the same own port.

### DESCRIPTION OF EMBODIMENTS

Communication errors detected in an access to a memory device in response to an access request to a virtual volume include a communication error that is detectable before the access, and a communication error that is detected after the access is executed.

When the latter communication error is detected, for example, a control device switches an access path to be used, and accesses again the memory device. Moreover, the latter communication error further includes a communication error that is detected by a retry out of the access. In this case, the control device accesses the memory device a plurality of times before a communication error is detected. In any cases, when a communication error is detected after the access is executed to increase the number of accesses from the control device to the memory device. This results in a longer response time from an access being requested with respect to the virtual volume to a response thereto, thereby causing a problem of lowering a response performance.

Accordingly, in order to suppress the number of accesses from the control device to the memory device, the challenge is to decrease the number of communication error detection times after the access is executed.

Hereinafter, embodiments of the disclosure are described with reference to the drawings.

### First Embodiment

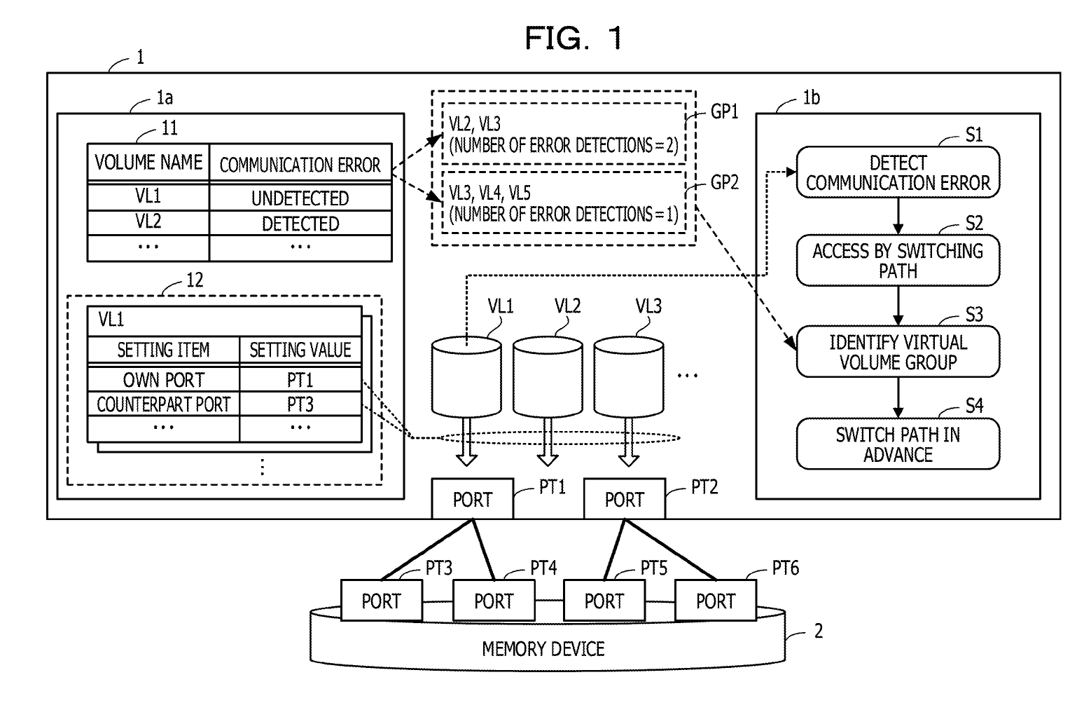

FIG. 1 is a diagram illustrating a configuration example and a process example of a storage system according to a first embodiment. The storage system illustrated in FIG. 1 includes a storage control device 1 and a memory device 2. Moreover, the storage control device 1 and the memory device 2 are coupled to each other via a plurality of access paths. For example, the storage control device 1 includes ports PT1 and PT2 for communicating with the memory device 2, and the memory device 2 includes ports PT3 to PT6 for communicating with the storage control device 1. Further, it is assumed that as access paths between the storage control device 1 and the memory device 2, access paths that respectively pass through the ports PT1 and PT3, the ports PT1 and PT4, the ports PT2 and PT5, and the ports PT2 and PT6 are present.

In addition, in the storage system, virtual volumes VL1, VL2, VL3, . . . that are implemented using a memory area of the memory device 2 are set. The storage control device 1 has a function of accepting an access request to the virtual volumes VL1, VL2, VL3, . . . . For example, the storage control device 1 accepts an access request to the virtual volumes VL1, VL2, VL3, . . . from a host device, which is not illustrated.

The storage control device 1 includes a memory unit 1a and a controller 1b. The memory unit 1a is implemented, for example, as a memory area of a memory device, which is not illustrated, included in the storage control device 1. The controller 1b is implemented, for example, as a processor, which is not illustrated, included in the storage control device 1.

The memory unit 1a stores therein error detection information 11 and setting information 12.

In the error detection information 11, information indicating whether a communication error is detected when the storage control device 1 accesses the memory device 2 in response to an access request to each of the virtual volumes VL1, VL2, VL3, . . . is registered, for each of the virtual volumes VL1, VL2, VL3, . . . . In the example of the error detection information 11 illustrated in FIG. 1, no communication error being detected for the virtual volume VL1, and a communication error being detected for the virtual volume VL2 are registered.

In the setting information 12, setting values respectively corresponding to a plurality of setting items for each of the virtual volumes VL1, VL2, VL3, . . . are registered. As for such setting items, at least, out of the plurality of access paths with the memory device 2, path setting items related to a use path that is used when the storage control device 1 accesses the memory device 2 is used. In other words, in the setting information 12, at least, out of the plurality of access paths with the memory device 2, path setting items related to a use path that is used when the storage control device 1 accesses the memory device 2 is used are set for each of the virtual volumes VL1, VL2, VL3, . . . .

In the example of the setting information 12 illustrated in FIG. 1, setting values respectively corresponding to setting items of an “own port” and a “counterpart port” are set. The “own port” indicates a port on the storage control device 1 side out of ports included in the use path, and the “counterpart port” indicates a port on the memory device 2 side out of the ports included in the use path. Accordingly, each of the “own port” and the “counterpart port” is one of the path setting items related to the use path.

In the example of FIG. 1, it is assumed that as a use path of the virtual volume VL1, an access path that passes through the ports PT1 and PT3 is set as a use path. In this case, as illustrated in FIG. 1, in the setting information 12, “PT1” and “PT3” are respectively set to the “own port” and the “counterpart port” for the virtual volume VL1. Moreover, in the example of FIG. 1, it is assumed that as a use path of the virtual volume VL2, an access path that passes through the ports PT2 and PT5 is set as a use path. In this case, although the illustration is omitted, in the setting information 12, “PT2” and “PT5” are respectively set to the “own port” and the “counterpart port” for the virtual volume VL2.

The controller 1b accesses the memory device 2 when an access to each of the virtual volumes VL1, VL2, VL3, . . . is requested, based on setting values corresponding to the path setting items related to the use path, out of the setting items of the setting information 12. For example, when an access to the virtual volume VL1 is requested, the controller 1b accesses the memory device 2 using the access path that passes through the ports PT1 and PT3, based on “PT1” and “PT3” that are respectively set to the “own port” and the “counterpart port”.

Next, processing by the controller 1b in a case where a communication error is detected in an access to the memory device 2 in response to an access request to each of the virtual volumes VL1, VL2, VL3, . . . is described.

It is assumed that the controller 1b detects a communication error when accessing the memory device 2, for example, in response to an access request to the virtual volume VL1 (Step S1). In this case, the controller 1b switches the use path corresponding to the virtual volume VL1, and accesses the memory device 2 again (Step S2).

Together with this, the controller 1b identifies, based on the error detection information 11, one virtual volume group, out of a plurality of virtual volume groups (Step S3). Hereinafter, the virtual volume group thus identified is described as an “identified virtual volume group”. The respective virtual volumes are extracted such that other virtual volumes each having the setting value that matches that of the virtual volume VL1 in which a communication error is detected, out of the virtual volumes VL1, VL2, VL3, . . . , are extracted respectively using different setting items as extraction conditions, out of the plurality of setting items in the setting information 12.

For example, as at least one extraction condition, the path setting item related to the use path is used. As an example in this case, the “own port” and the “counterpart port”, each of which is one of the path setting items, may be used as an extraction condition. In this case, a group of virtual volumes in which “PT1” is set to the “own port”, and a group of virtual volumes in which “PT3” is set to the “counterpart port” are extracted. Moreover, for example, as a setting item used as an extraction condition, a redundant array of inexpensive disks (RAID) group to which each of the virtual volumes VL1, VL2, VL3, . . . belongs may be further used.

The controller 1b identifies the identified virtual volume group, out of the plurality of virtual volume groups extracted in this manner, based on the error detection information 11. Further, the controller 1b switches the use path for all the virtual volumes in which no communication error is detected, out of the virtual volumes included in the identified virtual volume group identified by the abovementioned procedure (Step S4).

Here, at Step S3, the controller 1b uses the error detection information 11 to allow the controller 1b to identify the identified virtual volume group, based on occurrence statuses of a communication error in the virtual volumes included in each of the plurality of virtual volume groups. For example, when the extracted virtual volume groups include a virtual volume group in which a communication error is detected in a large number of virtual volumes, it is estimated that when an access is requested in the future to the other virtual volumes included in the virtual volume group, a communication error is detected with high possibility. Accordingly, such a virtual volume group is identified as an identified virtual volume group.

FIG. 1 illustrates a case where the virtual volume groups GP1 and GP2 are extracted, as one example. The virtual volume group GP1 includes the virtual volumes VL2 and VL3. Moreover, in accordance with the error detection information 11, a communication error is detected in two virtual volumes, out of the virtual volumes included in the virtual volume group GP1. This obtains the number of error detections of “2” in the virtual volume group GP1. Meanwhile, the virtual volume group GP2 includes the virtual volumes VL3 to VL5. Moreover, in accordance with the error detection information 11, a communication error is detected in one virtual volume, out of the virtual volumes included in the virtual volume group GP2. This obtains the number of error detections of “1” in the virtual volume group GP2.

For example, when a communication error is detected in virtual volumes more than a half among the virtual volumes included in a virtual volume group, it is assumed that the virtual volume group is identified as an identified virtual volume group. In this case, the virtual volume group GP1 is identified as an identified virtual volume group.

Meanwhile, as for an communication error that is detected not before but after the controller 1b accesses the memory device 2, a fault occurrence portion that is an occurrence factor of the error is unable to be identified in many cases. With the process at Step S3, the setting item that is used as an extraction condition in order to extract an identified virtual volume group is related to the fault occurrence portion with high possibility. For example, when the setting item indicating a port is used, a fault occurs with high possibility in a port indicated by a setting value of the setting item or a portion close to the port. Therefore, with the process at Step S3, even if the controller 1b is unable to identify a fault occurrence portion by the detection of a communication error, the controller 1b is able to appropriately estimate a virtual volume in which a communication error is detected with high possibility in the future.

Accordingly, at Step S4, the controller 1b is able to switch the use path in advance relative to a virtual volume in which a communication error is detected with high possibility in the future. This may reduce the possibility of a communication error being detected when the storage control device 1 thereafter accesses the memory device 2 in response to an access request to each of the virtual volumes VL1, VL2, VL3, . . . .

A decrease in the number of detections of a communication error may decrease the number of accesses from the storage control device 1 to the memory device 2. For example, when a communication error is detected, as the process at Step S2, the access path is switched, and the access to the memory device 2 is executed again. With the decrease in the number of detections of a communication error, the number of executions of such a re-access also decreases. Moreover, the communication error detected in an access to the memory device 2 includes a communication error due to a retry out of the access. In this case, the access to the memory device 2 is executed a plurality of times before a communication error is detected. With the decrease in the number of detections of a communication error, the occasion in which the access is executed a plurality of times in this manner decreases.

### Second Embodiment

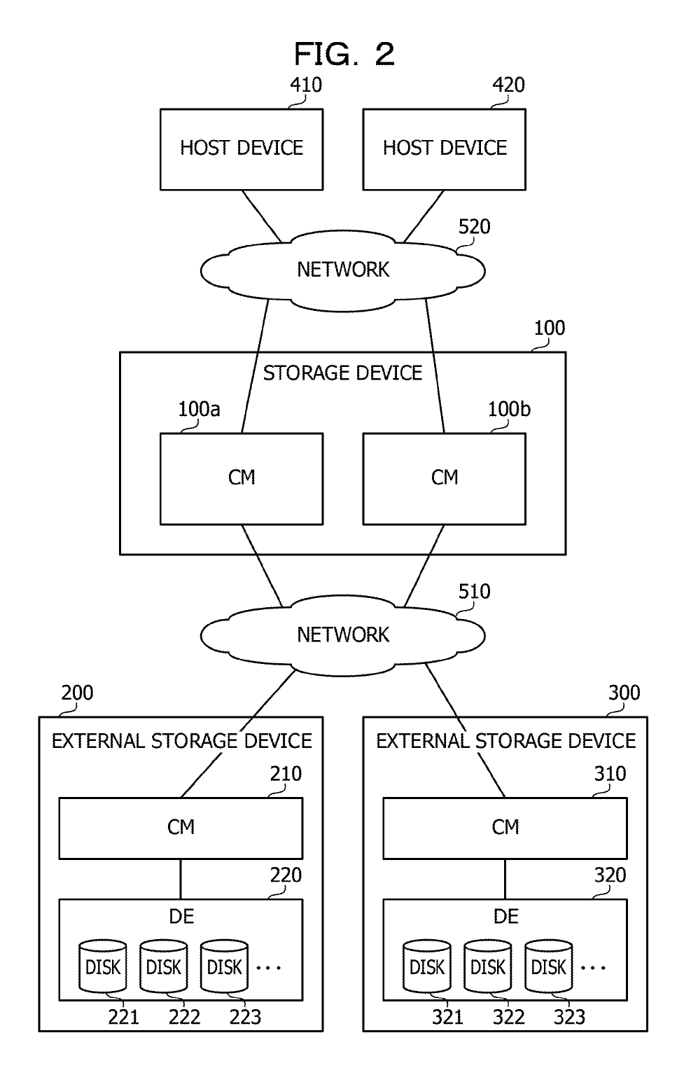

FIG. 2 is a diagram illustrating a configuration example of a storage system according to a second embodiment. The storage system illustrated in FIG. 2 includes a storage device 100, external storage devices 200 and 300, and host devices 410 and 420. The storage device 100 includes controller modules (CMs) 100a and 100b. The external storage device 200 includes a CM 210 and a drive enclosure (DE) 220. The external storage device 300 includes a CM 310 and a DE 320.

The CMs 100a and 100b are coupled to the CMs 210 and 310 via a network 510. Moreover, the host devices 410 and 420 are coupled to the CMs 100a and 100b via a network 520. The networks 510 and 520 each are, for example, a storage area network (SAN) that uses a fiber channel (FC), an Internet small computer system interface (iSCSI), or the like.

The CMs 100a and 100b are control devices that control accesses to memory devices mounted on the DEs 220 and 320, in response to requests from the host devices 410 and 420. The CM 210 is a control device that accesses the memory device mounted on the DE 220 in response to requests from the CMs 100a and 100b. The CM 310 is a control device that accesses the memory device mounted on the DE 320 in response to requests from the CMs 100a and 100b.

Noted that the CMs 100a and 100b are coupled to the CMs 210 and 310 with a “multi-path”, which is the redundant access path.

The DE 220 includes a plurality of disks 221, 222, 223, . . . , as memory devices, being mounted thereon. Each of the disks 221, 222, 223, . . . is a nonvolatile memory device, such as a hard disk drive (HDD) or a solid state drive (SSD). The DE 320 similarly includes a plurality of disks 321, 322, 323, . . . , as memory devices, being mounted thereon. Each of the disks 321, 322, 323, . . . is a nonvolatile memory device, such as an HDD or an SSD.

In this storage system, the CMs 100a and 100b of the storage device 100 provide virtual volumes with respect to the host devices 410 and 420. One virtual volume is a virtual logic volume that is generated using a physical memory area by the disks mounted on the DE 220, 320. In the following explanation, it is assumed that a physical memory area by one or more disks that are mounted on either one of the DEs 220 and 320 is allocated with respect to one virtual volume. Moreover, an external storage device on which a DE that implements a physical memory area of a given virtual volume is mounted is abbreviated as an “external storage device corresponding to the virtual volume” in some cases.

Access control to which of a virtual volume to be in charge is set to each of the CMs 100a and 100b. The host device 410, 420 transmits an access request to a virtual volume to the CM, out of the CMs 100a and 100b, which is in charge of the access control to the virtual volume. This enables an access to the virtual volume.

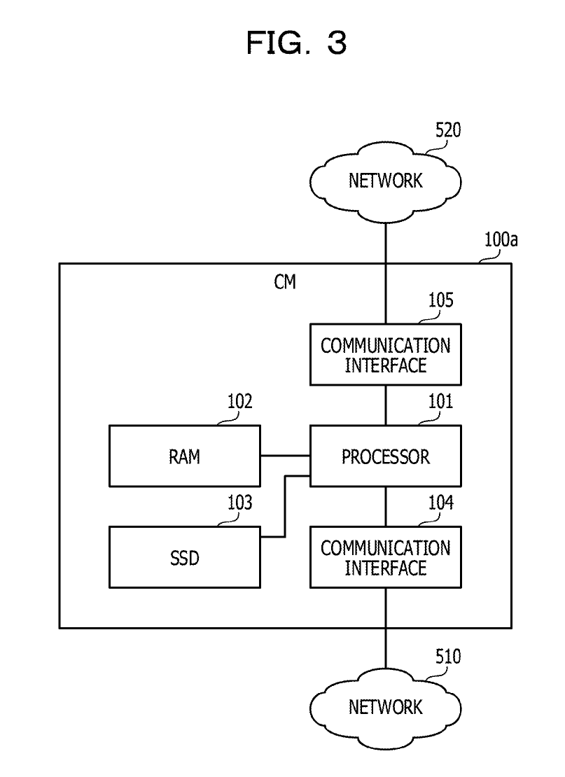

FIG. 3 is a diagram illustrating a hardware configuration example of a CM. FIG. 3 illustrates the CM 100a, as an example. The CM 100a includes a processor 101, a random access memory (RAM) 102, an SSD 103, and communication interfaces 104 and 105.

The processor 101 controls the whole CM 100a in a centralized manner. The processor 101 is, for example, a central processing unit (CPU), a micro processing unit (MPU), a digital signal processor (DSP), an application specific integrated circuit (ASIC), or a programmable logic device (PLD). Moreover, the processor 101 may be a combination of two or more elements among the CPU, the MPU, the DSP, the ASIC, and the PLD.

The RAM 102 is used as a main storage device of the CM 100a. The RAM 102 temporarily stores therein at least a part of operating system (OS) programs and application programs that the processor 101 is caused to execute. Moreover, the RAM 102 stores therein various kinds of data that is used for the processing by the processor 101.

The SSD 103 is used as an auxiliary memory device of the CM 100a. The SSD 103 stores therein the OS programs, the application programs, and various kinds of data.

The communication interface 104 communicates with the CMs 210 and 310 via the network 510. The communication interface 105 communicates with the host devices 410 and 420 via the network 520.

The hardware configuration in the foregoing implements the processing function of the CM 100a. Noted that the CMs 100b, 210, 310 are also implemented with the hardware configurations similar to that of the CM 100a.

Next, an exemplary configuration of virtual volumes and RAID groups and an exemplary configuration of access paths, which are set in the storage system, are described.

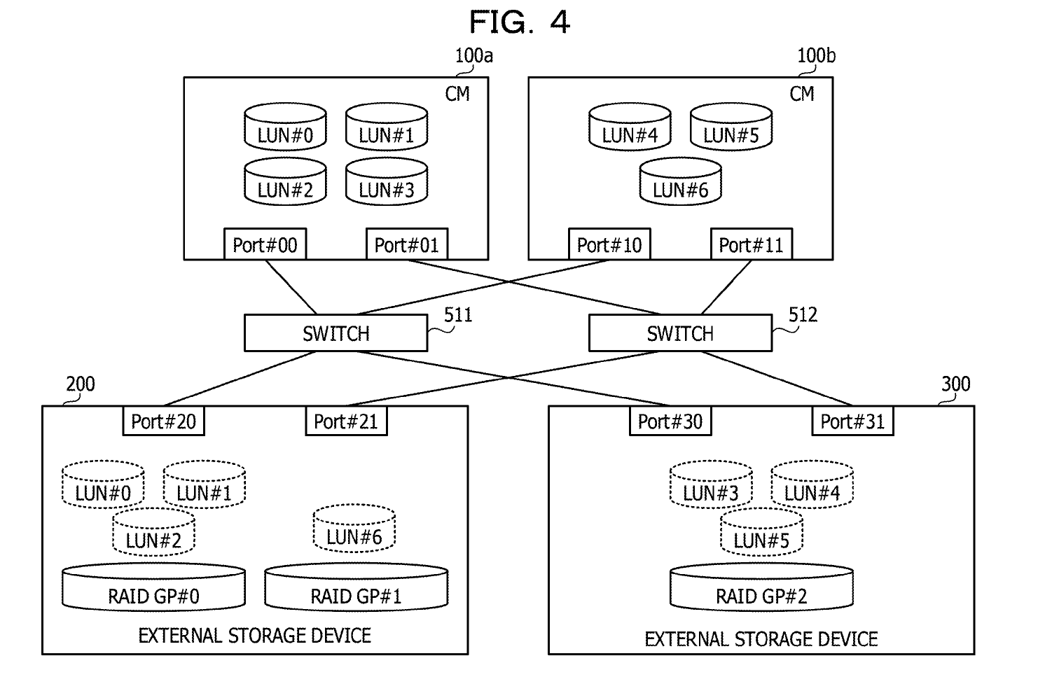

FIG. 4 is a diagram illustrating a configuration example of virtual volumes, RAID groups, and access paths. Noted that a virtual volume is described as “logical unit number (LUN)” in some cases in the following explanation. Moreover, a LUN having an identification number “x” is expressed as a “LUN #x”, a RAID group having an identification number “x” is expressed as a “RAID group #x”, and a port having an identification number “x” is expressed as a “port #x”.

Noted that the RAID group is a logic memory area for which a plurality of disks is used. A logic memory area cut out from a RAID group is allocated to a virtual volume (LUN). Moreover, data of the LUN that is allocated to a RAID group is made to be redundant and recorded in a plurality of disks, due to the RAID control in accordance with a set RAID level.

As illustrated in FIG. 4, LUNs #0 to #6 are set in the storage system. The CM 100a is in charge of the access control to the LUNs #0 to #3. The CM 100b is in charge of the access control to the LUNs #4 to #6. Meanwhile, RAID groups (GPs) #0 and #1 are set to the external storage device 200. Moreover, a RAID group (GP) #2 is set to the external storage device 300.

Further, the LUNs #0 to #2 are allocated to the RAID group #0. Accordingly, when the host device 410, 420 requests an access to the LUN #0 to #2, an access from the CM 100a to the external storage device 200 is performed. Moreover, the external storage device 200 serves as an external storage device corresponding to “the LUNs #0 to #2”.

Moreover, the LUN #6 is allocated to the RAID group #1. Accordingly, when the host device 410, 420 requests an access to the LUN #6, an access from the CM 100b to the external storage device 200 is performed. Moreover, the external storage device 200 serves as an external storage device corresponding to “LUN #6”.

In addition, the LUNs #3 to #5 are allocated to the RAID group #2. Accordingly, when the host device 410, 420 requests an access to the LUN #3, an access from the CM 100a to the external storage device 300 is performed. Accordingly, when the host device 410, 420 requests an access to the LUN #4, #5, an access from the CM 100b to the external storage device 300 is performed. Further, the external storage device 300 serves an external storage device corresponding to “the LUNs #3 to #5”.

Next, an access path between the CMs 100a and 100b and the external storage devices 200 and 300 is described using FIG. 4.

The CMs 100a and 100b are coupled to the external storage devices 200 and 300 via switches 511 and 512. In other words, the access path between the CMs 100a and 100b and the external storage devices 200 and 300 is made to be redundant to include an access path that passes through the switch 511 and an access path that passes through the switch 512.

the CM 100a includes a port #00 and a port #01. The port #00 is coupled to the switch 511, and the port #01 is coupled to the switch 512. Moreover, the CM 100b includes a port #10 and a port #11. The port #10 is coupled to the switch 511, and the port #11 is coupled to the switch 512.

The external storage device 200 includes a port #20 and a port #21. The port #20 is coupled to the switch 511, and the port #21 is coupled to the switch 512. Moreover, the external storage device 300 includes a port #30 and a port #31. The port #30 is coupled to the switch 511, and the port #31 is coupled to the switch 512. Noted that actually, the ports #20 and #21 are provided in the CM 210, and the ports #30 and #31 are provided in the CM 310.

With such configuration, an access path via the port #00, the switch 511, and the port #20, and an access path via the port #01, the switch 512, and the port #21 are formed between the CM 100a and the external storage device 200. Accordingly, with respect to each of the LUNs #0 to #2, one of these access paths is set as a priority path that is used in the normal time, and the other access path is set as an alternate path for an alternative.

Moreover, an access path via the port #00, the switch 511, and the port #30, and an access path via the port #01, the switch 512, and the port #31 are formed between the CM 100a and the external storage device 300. Accordingly, with respect to LUN #3, one of these access paths is set as a priority path, and the other access path is set as an alternate path.

In addition, an access path via the port #10, the switch 511, and the port #20, and an access path via the port #11, the switch 512, and the port #21 are formed between the CM 100b and the external storage device 200. Accordingly, with respect to LUN #6, one of these access paths is set as a priority path, and the other access path is set as an alternate path.

Moreover, an access path via the port #10, the switch 511, and the port #30, and an access path via the port #11, the switch 512, and the port #31 are formed between the CM 100b and the external storage device 300. Accordingly, with respect to each of the LUNs #4 and #5, one of these access paths is set as a priority path, and the other access path is set as an alternate path.

In the present embodiment, which one of the two access paths is set as a priority path and which one is set as an alternate path are set for each virtual volume (LUN).

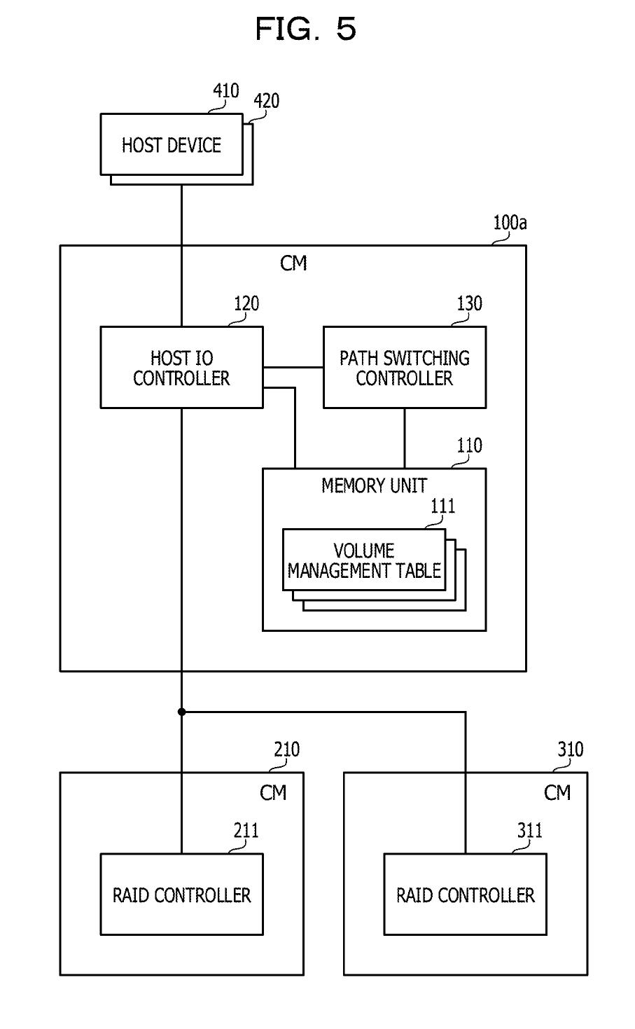

FIG. 5 is a block diagram illustrating a configuration example of a processing function included in the CM. The CM 100a includes a memory unit 110, a host input/output (IC)) controller 120, and a path switching controller 130. The memory unit 110 is implemented, for example, as a memory area of the RAM 102 or the SSD 103. The processing by the host IO controller 120 and the processing by the path switching controller 130 are implemented in such a manner that the processor 101 executes a predetermined program.

The memory unit 110 stores therein a volume management table 111 for each virtual volume. The volume management table 111 holds information related to the configuration of a virtual volume, including information on a RAID group to which the virtual volume belongs and an access path to an external storage device. In addition to this, the volume management table 111 holds information related to the type of an error that is detected in an access to an external storage device corresponding to the virtual volume and switching of an access path that is executed in response to the occurrence of an error.

The host IO controller 120 executes the access control to a virtual volume in response to a request from the host device 410, 420. Specifically, the host IO controller 120 receives an IO command for accessing the virtual volume from the host device 410, 420. The host IO controller 120 identifies, based on the volume management table 111 corresponding to the virtual volume, an external storage device corresponding to the virtual volume, and transmits the IO command to the identified external storage device. With this, the host IO controller 120 executes IO processing with respect to a physical memory area that is allocated to the virtual volume.

Moreover, in response to an access request to a given virtual volume, in a case where the host IO controller 120 detects an error when accessing the external storage device corresponding to the virtual volume, the host IO controller 120 switches the access path for the virtual volume to the alternate path. Together with this switching, the host IO controller 120 instructs the path switching controller 130 to execute preliminary path switching processing related to the other volumes.

The path switching controller 130 executes the preliminary path switching processing related to the other volumes in accordance with the instruction from the host IO controller 120. In this preliminary path switching processing, the path switching controller 130 identifies a virtual volume the access path of which is estimated to be desirably switched in advance, out of the other virtual volumes, and switches the access path relative to the identified virtual volume to the alternate path.

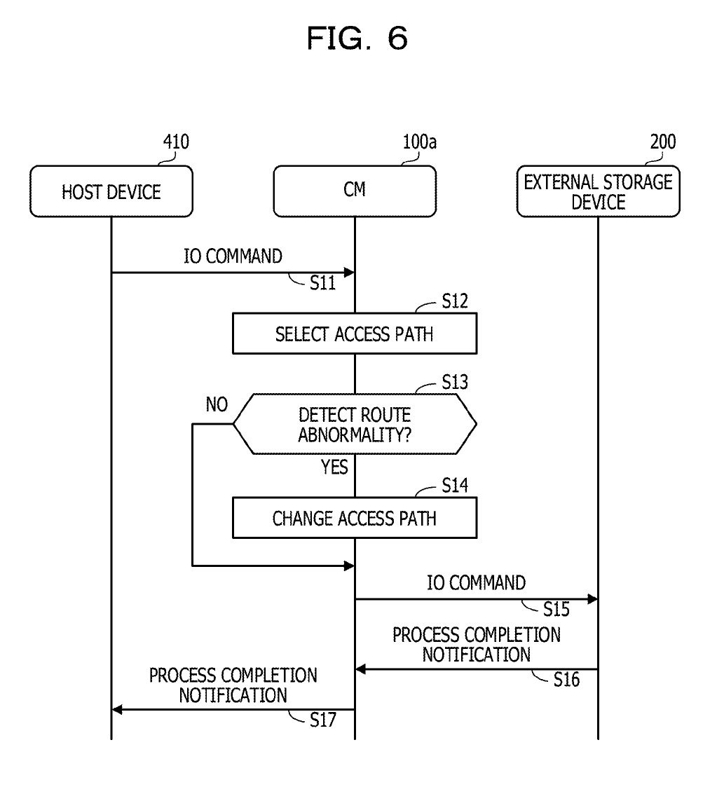

Here, FIG. 6 is a sequence diagram indicating a comparative example of a process procedure when an access to a given virtual volume is requested. Problems in the comparative example are described using FIG. 6.

FIG. 6 illustrates, as an example, a case where the host device 410 requests an access to a virtual volume for which the CM 100a is in charge of access control. Moreover, an external storage device corresponding to the virtual volume is the external storage device 200.

The host device 410 transmits an IO command for accessing the virtual volume to the CM 100a (Step S11). The IO command to be transmitted is, for example, a read command or a write command. The host IO controller 120 of the CM 100a selects an access path based on the volume management table 111 corresponding to the virtual volume (Step S12). Herein, it is assumed that a priority path is selected.

The host IO controller 120 executes preparation processing for transmitting an IO command via the selected access path. In this process, the host IO controller 120 is able to detect an error (hereinafter, described as “error due to the route abnormality”) the error factor of which is a “route abnormality”, via the selected access path (Step S13). The error due to the route abnormality includes, for example, a case where the communication link goes down in the access path or a case where a port at the CM 100a side on the access path does not operate due to the abnormality. In these cases, the host IO controller 120 is able to detect the occurrence of an error in the abovementioned preparation processing, before transmitting an IO command to the external storage device 200.

If the host IO controller 120 detects an error due to the route abnormality, the host IO controller 120 changes the access path to an alternate path (Step S14), and transmits an IO command to the external storage device 200 via the alternate path (Step S15). On the other hand, if the host IO controller 120 detects no error due to the route abnormality, the host IO controller 120 skips Step S14, and transmits an IO command to the external storage device 200 via the priority path (Step S15).

When the host IO controller 120 receives a completion notification of the process from the external storage device 200 (Step S16), the host IO controller 120 respond to the host device 410 by transmitting the completion notification of the process thereto (Step S17).

Meanwhile, an error that occurs in an access to the virtual volume corresponding to the external storage device 200, some error may be detected after the access to the external storage device 200 (in other words, after an IO command being transmitted), as that at Step S15. This includes, for example, an error that is determined from a response content with respect to the transmission of the IO command or an error caused by a retry out of the transmission of the IO command. The latter error caused by the retry out is detected when a response with respect to the transmission of the IO command is unable to be received during a certain period of time, the IO command is retransmitted, and the retransmission is repeated a predetermined number of times during a certain period of time. Hereinafter, an error that is detected after the access to the external storage device 200 in this manner is described as an “error due to the volume abnormality”.

The error due to the route abnormality is able to be detected before the access to the external storage device 200. Therefore, when the host IO controller 120 detects an error due to the route abnormality, the host IO controller 120 is able to normally access the external storage device 200 after switching the access path to the alternate path. However, the error due to the volume abnormality is able to be detected only after the access to the external storage device 200. Therefore, for example, when an operating in which the access path is changed if an error is detected and an IO command is transmitted again is performed, the IO command is transmitted twice at the minimum for one virtual volume. Moreover, when an error due to the retry out is detected, the IO command is transmitted a plurality of times before the error is detected.

Accordingly, the frequent occurrence of the error due to the volume abnormality increases the number of transmission times of the IO command to the external storage device 200, thereby resulting in a high communication load between the CM 100a and the external storage device 200. As a result, the response time with respect to an access request from the host device 410 becomes longer, which causes a problem of the response performance becoming worse.

Hereinafter, referring back to FIG. 5, the explanation of the present embodiment is continued.

As for the abovementioned problem, the path switching controller 130 executes preliminary path switching processing to decrease the number of transmission times of the IO command to the external storage device. As described above, the preliminary path switching processing is executed when an error is detected in the access to a given external storage device corresponding to the virtual volume. Noted that a virtual volume in which an error is detected in the access to the corresponding external storage device is described as an “error volume” in the following explanation.

In the preliminary path switching processing, the path switching controller 130 identifies a virtual volume having a high possibility that the error due to the same factor occurs, out of the other virtual volumes other than the error volume. The path switching controller 130 switches the access path of each of all the identified virtual volumes to the alternate path. This reduces the possibility that an error occurs in an access to the corresponding external storage device, in response to an access request to the identified virtual volume from the host device. In other words, as for the virtual volumes that each are estimated by the preliminary path switching processing to have a high possibility that an error occurs in the access to the corresponding external storage device, the access path is switched in advance to the alternate path.

However, unlike the error due to the route abnormality, when an error due to the retry out occurs, the CM as a transmission source is unable to identify a fault occurrence portion that is a factor of the error. Moreover, the CM is unable to identify a fault occurrence portion of some error, out of the errors that are distinguished based on the response content with respect to the IO command. The fault occurrence portion is unable to be identified as the above, so that the path switching controller 130 is unable to appropriately determine that the access path of which virtual volume is to be switched in the preliminary path switching processing, out of the other virtual volumes.

Therefore, the path switching controller 130 extracts a plurality of virtual volume groups each having a setting value similar to that of the error volume, using different setting items respectively as the extraction conditions, based on the setting content of the volume management table 111. The path switching controller 130 refers to the volume management table 111 to grasp the occurrence status of an error due to the volume abnormality for each extracted virtual volume group. Further, when a virtual volume group in which the error due to the volume abnormality is detected in a large number of virtual volumes is present among the virtual volume groups, the path switching controller 130 switches the access path to the alternate path for all the virtual volumes included in the virtual volume group.

The abovementioned extraction condition is a condition for determining a “switching range” that indicates the range of the virtual volumes as targets the access paths of which are concurrently switched. The switching range in accordance with the extraction condition includes switching ranges R1 to R4 below.

The switching range R1 includes only a virtual volume in which an error is detected. In other words, when the switching range R1 is applied, only the virtual volume in which an error is detected serves as a target of path switching. In this case, extraction of other virtual volumes other than the virtual volume in which an error is detected is not performed. Accordingly, actually, the following switching ranges R2 to R4 are applied in the preliminary path switching processing.

The switching range R2 is a range of the virtual volumes that are extracted with an extraction condition of belonging to the same RAID group. When the switching range R2 is applied, a virtual volume that belongs to the same RAID group as the virtual volume in which an error is detected serves as a target of path switching.

The switching range R3 is a range of the virtual volumes that are extracted with an extraction condition of using the same counterpart port as a priority path. When the switching range R3 is applied, a virtual volume that uses the same counterpart port as the virtual volume in which an error is detected serves as a target of path switching. Here, the “counterpart port” indicates ports included in the external storage devices 200 and 300.

The switching range R4 is a range of the virtual volumes that are extracted with an extraction condition of using the same own port as a priority path. When the switching range R4 is applied, a virtual volume that uses the same own port, as a priority path, as the virtual volume in which an error is detected serves as a target of path switching. Here, the “own port” indicates a port included in either one of the CMs 100a and 100b of the storage device 100.

The path switching controller 130 identifies, out of the abovementioned path switching ranges R2 to R4, based on an error detection status of the virtual volumes included in each switching range, a switching range serving a switching target of the path. This allows the appropriate estimation of a switching range including virtual volumes in which an error is already detected and virtual volumes in which an error is detected with high possibility in the future. Further, the path switching controller 130 switches the access path to the alternate path, for all the virtual volumes included in the identified switching range.

Here, the abovementioned switching ranges R2, R3, and R4 are the ranges of the virtual volumes that are extracted respectively using the setting items of “RAID group”, “counterpart port” of “priority path information”, and “own port” of “priority path information”, as extraction conditions. Among these, the RAID group may be a setting item for substantially identifying a disk in the external storage devices 200 and 300. Therefore, these three setting items may be setting items related to the configuration on the path from the storage device 100 to the disk in the external storage device 200, 300.

Using such setting items as the extraction conditions enables the path switching controller 130 to identify the switching range including a virtual volume that is estimated to be related to a fault occurrence portion. This makes it possible to appropriately identify virtual volumes in which an error is detected with high possibility in the future although a fault occurrence portion is unable to be identified, and switch the access paths of those virtual volumes in advance to the alternate paths.

Next, as illustrated in FIG. 5, the CM 210 includes a RAID controller 211. The processing by the RAID controller 211 is implemented in such a manner that a processor included in the CM 210 executes a predetermined program, for example. The RAID controller 211 forms a RAID group using a disk that is mounted on the DE 220. The RAID controller 211 accepts an access request to the formed RAID group from the CM 100a, 100b, and executes IO processing with respect to the disk in accordance with the RAID level set in the RAID group.

Moreover, the CM 310 includes a RAID controller 311. The processing by the RAID controller 311 is implemented in such a manner that a processor included in the CM 310 executes a predetermined program, for example. The RAID controller 311 forms a RAID group using a disk that is mounted on the DE 320. The RAID controller 311 accepts an access request to the formed RAID group from the CM 100a, 100b, and executes IO processing with respect to the disk in accordance with the RAID level set in the RAID group.

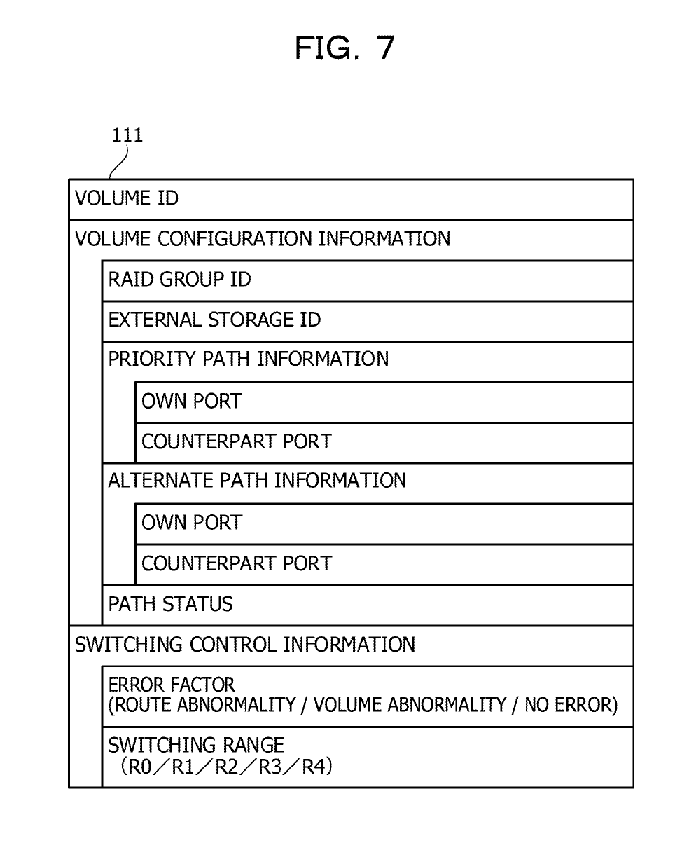

FIG. 7 is a diagram illustrating a data configuration example of a volume management table. As described above, the memory unit 110 stores therein the volume management table 111 that is created for each virtual volume.

In the volume management table 111, a volume ID, volume configuration information, and switching control information are registered. The volume ID indicates an identification number of the virtual volume.

The volume configuration information includes items of a RAID group ID, an external storage ID, priority path information, alternate path information, and a path status.

An identification number of the RAID group to which the virtual volume belongs is registered in the item of the RAID group ID. An identification number of the external storage device in which the RAID group is formed is registered in the item of the external storage ID.

An identification number of the device included in the priority path is registered in the item of the priority path information. The item of the priority path information includes at least items of the own port and the counterpart port. An identification number of the own port is registered in the item of the own port, and an identification number of the counterpart port is registered in the item of the counterpart port. An identification number of the device included in the alternate path is registered in the item of the alternate path information. The item of the alternate path information includes at least items of the own port and the counterpart port. An identification number of the own port is registered in the item of the own port, and an identification number of the counterpart port is registered in the item of the counterpart port. Status information indicating which one between the priority path and the alternate path is currently used is registered in the item of the path status.

The CM 100a, 100b determines the priority path of each virtual volume in accordance with, for example, the asymmetric logical unit access (ALUA) of the SCSI standard. Alternatively, the CM 100a, 100b may determine the priority path of each virtual volume in accordance with a designation operation by a user.

The switching control information includes items of an error factor and a switching range.

Information indicating whether an error occurs in the virtual volume, and indicating the factor of the error if the error occurs is registered in the item of the error factor. Specifically, information indicating any one of the “route abnormality”, the “volume abnormality”, and the “no error” is registered in the item of the error factor. In the initial state, information indicating the “no error” is registered.

Information indicating that, when the access path is switched to the alternate path for a virtual volume, the virtual volume is included in which of the switching ranges R1 to R4 described above, is registered in the item of the switching range. In addition, if the access path is not switched to the alternate path for the virtual volume, “R0” indicating a not-yet-switched state is registered in the item of the switching range. In the initial state, “R0” is registered.

The CMs 100a and 100b hold the common volume management tables 111. In other words, the CMs 100a and 100b hold not only the volume management table 111 corresponding to the virtual volume for which the own device is in charge of the access control, but also the volume management table 111 corresponding to the virtual volume for which the other CM is in charge of the access control.

Next, the processes by the CMs 100a and 100b are described using a flowchart. In the following explanation, the process by the CM 100a is described, however, the CM 100b is able to execute the similar process.

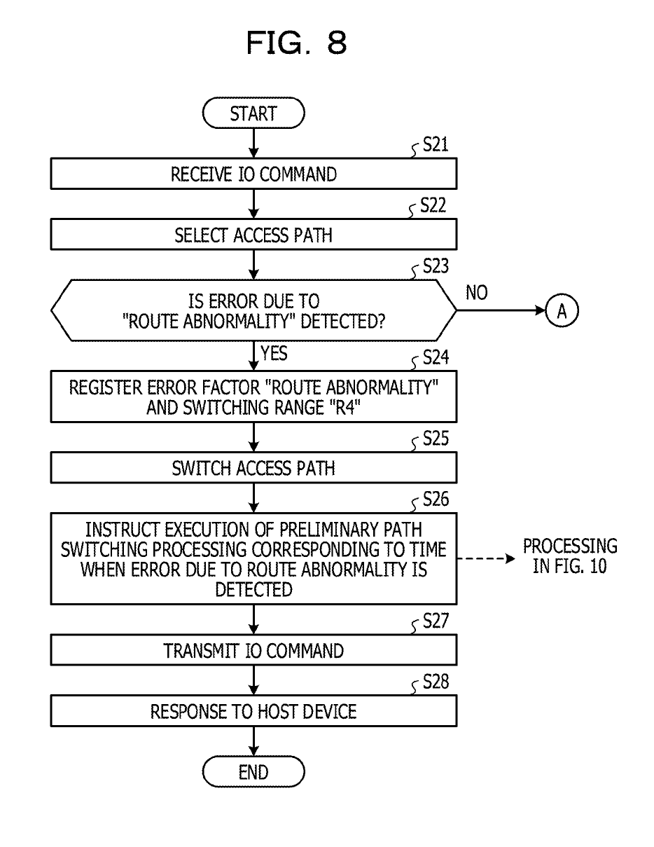

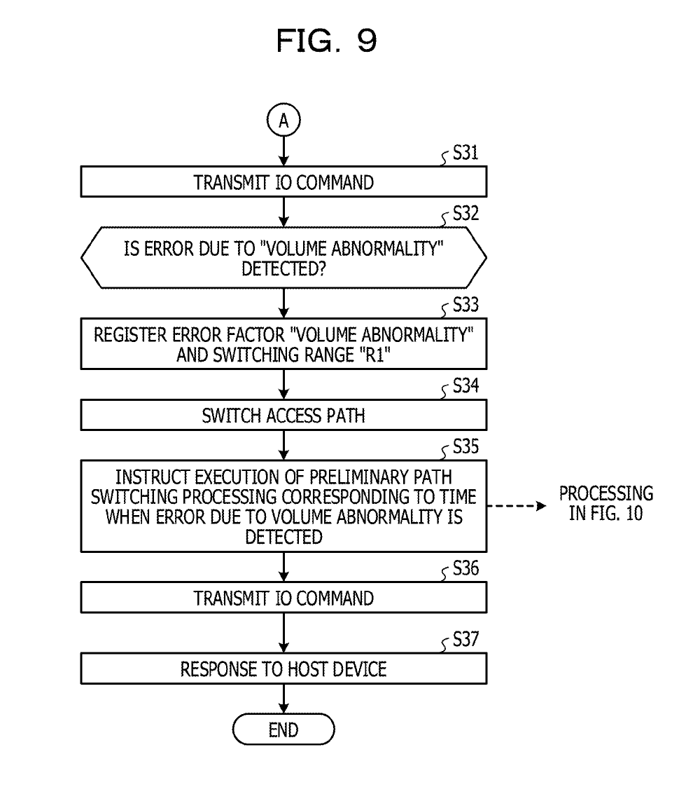

FIGS. 8 and 9 are flowcharts illustrating an example of IO control processing of a virtual volume.

[Step S21] The host IO controller 120 accepts an IO command for accessing the virtual volume (for example, write command or read command) from a host device. As an example herein, it is assumed that the host IO controller 120 accepts an IO command in which the LUN #0 is designated as an access destination, from the host device 410.

[Step S22] The host IO controller 120 refers to the volume management table 111 corresponding to the LUN #0, and selects an access path that is used in the access to an external storage device.

[Step S23] The host IO controller 120 executes preparation processing for transmitting an IO command to the external storage device using the access path selected at Step S22. The host IO controller 120 executes the process at Step S24 when detecting an error due to the route abnormality in this preparation processing, and executes the process at Step S31 in FIG. 9 when detecting no error due to the route abnormality.

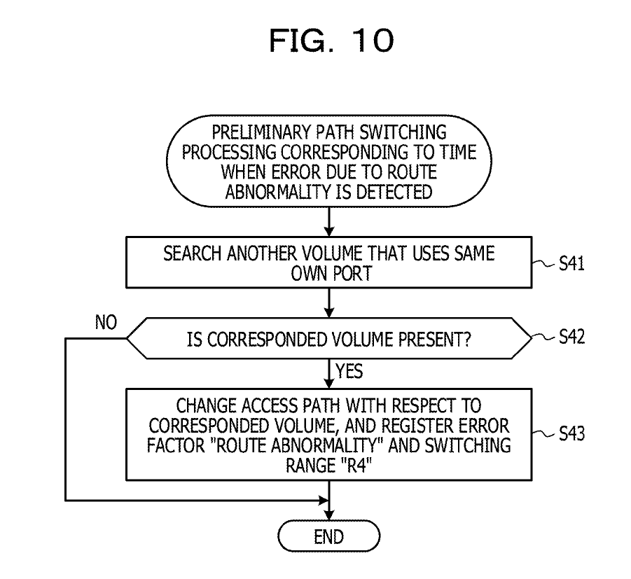

Noted that if the alternate path is selected at Step S22, the host IO controller 120 transmits a response indicating that the access is impossible to the host device 410, instead of executing the process at Step S24, and ends the processing.

[Step S24] The host JO controller 120 updates the registration information in the volume management table 111 corresponding to the LUN #0 as follows. The host JO controller 120 updates registration information on the error factor to “route abnormality”, and updates registration information on the switching range to “R4”.

[Step S25] The host JO controller 120 switches the access path that is used in the access from the priority path to the alternate path. Moreover, the host JO controller 120 updates the registration information on the path status to information indicating the alternate path being in use, in the volume management table 111 corresponding to the LUN #0.

[Step S26] The host JO controller 120 instructs the path switching controller 130 to execute preliminary path switching processing corresponding to the time when an error due to the route abnormality is detected. In this process, the host JO controller 120 notifies the path switching controller 130 of an error being detected in the LUN #0. This starts the processing in FIG. 10 in which an error volume is set to the LUN #0.

[Step S27] The host IO controller 120 transmits an IO command to the external storage device via the alternate path switched at Step S25. The external storage device as a transmission destination is identified from an external storage ID in the volume management table 111 corresponding to the LUN #0.

[Step S28] Upon reception of a completion notification of the IO processing from the external storage device, the host IO controller 120 transmits a response indicating that the JO processing is normally completed, to the host device 410.

Hereinafter, the explanation is continued using FIG. 9.

[Step S31] The host JO controller 120 transmits an JO command to the external storage device via the access path selected at Step S22. Similar to Step S27, the external storage device as a transmission destination is identified from an external storage ID in the volume management table 111 corresponding to the LUN #0.

[Step S32] The host IO controller 120 executes the process at Step S33 when an error due to the volume abnormality is detected, and executes the process at Step S37 when no error due to the volume abnormality is detected. When the error notified in the response with respect to the IO command, a volume abnormality is detected. Alternatively, a volume abnormality is also detected when a response with respect to the transmission of the IO command is unable to be received during a certain period of time, the IO command is retransmitted, and the retransmission is repeated during a certain period of time a predetermined number of times.

[Step S33] The host IO controller 120 updates the registration information in the volume management table 111 corresponding to the LUN #0 as follows. The host IO controller 120 updates registration information on the error factor to “volume abnormality”, and updates registration information on the switching range to “R1”.

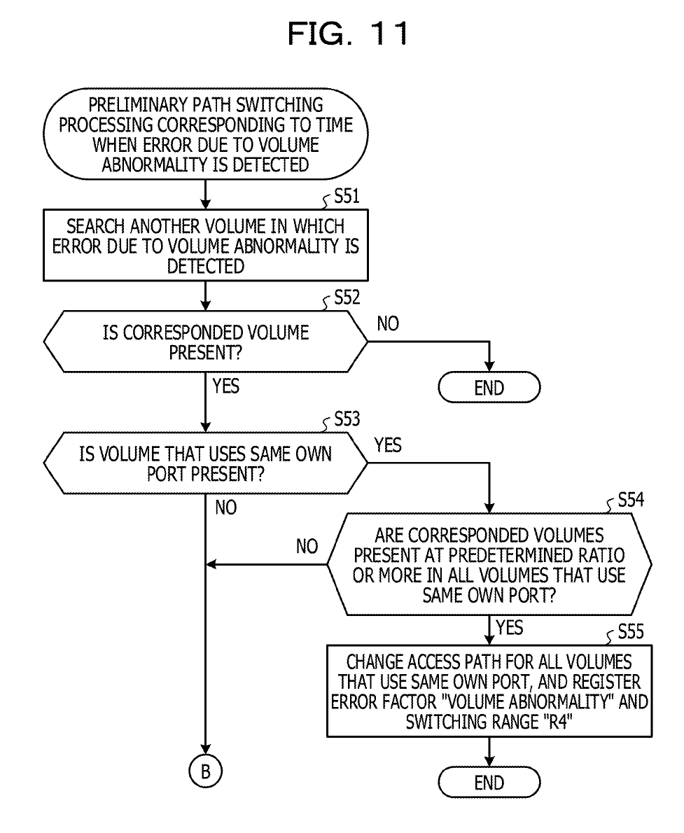

Noted that if the alternate path is selected at Step S22, the host IO controller 120 transmits a response indicating that the access is impossible to the host device 410, instead of executing the process at Step S33, and ends the processing.

[Step S34] The host IO controller 120 switches the access path that is used in the access from the priority path to the alternate path. Moreover, the host IO controller 120 updates the registration information on the path status to information indicating the alternate path being in use, in the volume management table 111 corresponding to the LUN #0.

[Step S35] The host IO controller 120 instructs the path switching controller 130 to execute preliminary path switching processing corresponding to the time when an error due to the volume abnormality is detected. In this process, the host IO controller 120 notifies the path switching controller 130 of an error being detected in the LUN #0. This starts the processing in FIG. 11 in which an error volume is set to the LUN #0.

[Step S36] The host IO controller 120 transmits an IO command to the external storage device via the alternate path switched at Step S34. The external storage device as a transmission destination is identified from an external storage ID in the volume management table 111 corresponding to the LUN #0.

[Step S37] Upon reception of a completion notification of the IO processing from the external storage device, the host IO controller 120 transmits a response indicating that the IO processing has been normally completed, to the host device 410.

FIG. 10 is a flowchart illustrating an example of preliminary path switching processing corresponding to the time when an error due to the route abnormality is detected. Herein, it is assumed that an error being detected in the LUN #0 is notified from the host IO controller 120. The processing in FIG. 10 may be executed immediately when the execution is instructed from the host IO controller 120, or may be executed at the timing asynchronous to the instruction timing.

[Step S41] The path switching controller 130 searches another virtual volume (LUN) that uses the same own port as the LUN #0 uses, as a priority path. Specifically, the path switching controller 130 identifies an own port included in the priority path from the volume management table 111 corresponding to the LUN #0. The path switching controller 130 identifies the volume management table 111 in which the own port included in the priority path is the same as the identified own port, out of other volume management tables 111. The path switching controller 130 outputs a virtual volume corresponding to the identified volume management table 111, as a search result. This identifies the virtual volumes other than the LUN #0, included in the switching range R4.

[Step S42] If another corresponded virtual volume is present, the path switching controller 130 executes the process at Step S43, and ends the processing if not present.

[Step S43] The path switching controller 130 updates the volume management table 111 corresponding to the corresponded virtual volume as follows. The path switching controller 130 updates the path status so as to indicate the alternate path being in use, and switches the access path to be used to the alternate path. Noted that when the alternate path is already used, the registration information on the path status is maintained without any change. Moreover, the path switching controller 130 updates the registration information on the error factor to “route abnormality”, and updates the registration information on the switching range to “R4”.

With the processing in FIG. 10 in the foregoing, the access path is switched to the alternate path, for all the other virtual volumes that each uses the same own port as the LUN #0 uses as a priority path. Accordingly, when an access to each of these virtual volumes is requested, no error due to the route abnormality is detected, thereby accelerating the preparation processing of the IO command.

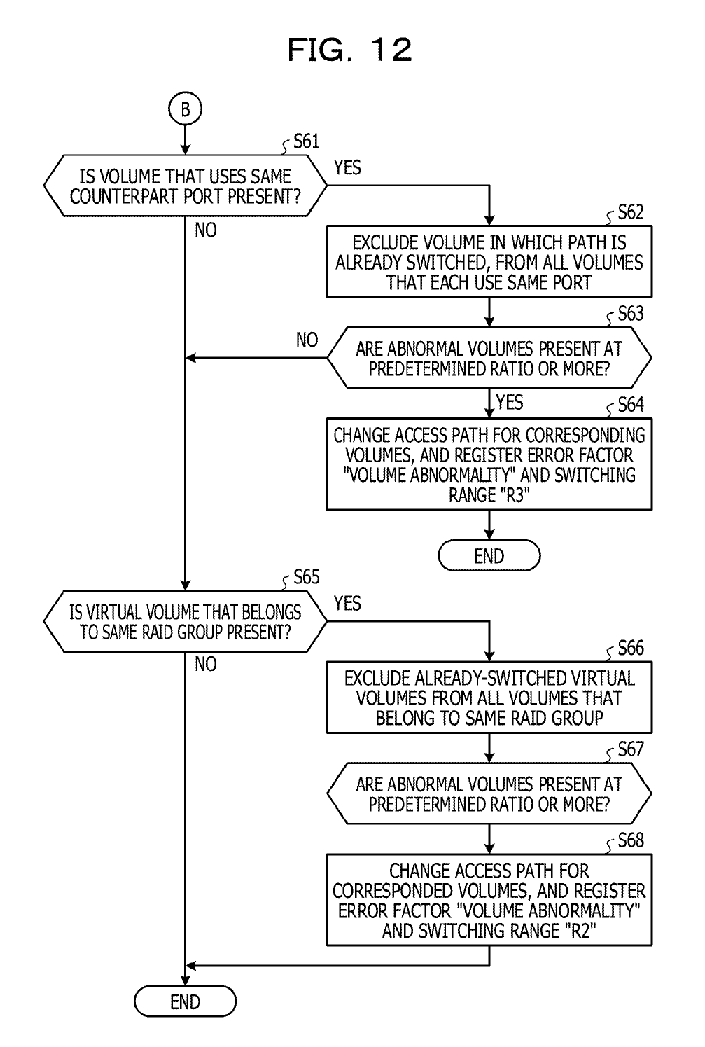

FIGS. 11 and 12 are flowcharts illustrating an example of preliminary path switching processing corresponding to the time when an error due to the volume abnormality is detected. Herein, it is assumed that an error being detected in the LUN #0 is notified from the host IO controller 120. The processing in FIG. 11 may be executed immediately when the execution is instructed from the host IO controller 120, or may be executed at the timing asynchronous to the instruction timing.

[Step S51] The path switching controller 130 searches a virtual volume in which an error due to the volume abnormality is detected, out of the other virtual volumes other than the LUN #0. Specifically, the path switching controller 130 identifies the volume management table 111 in which the “volume abnormality” is registered as an error factor, out of the volume management tables 111 respectively corresponding to the other virtual volumes.

[Step S52] If another corresponded virtual volume is present, the path switching controller 130 executes the process at Step S53, and ends the processing if not present.

[Step S53] The path switching controller 130 searches a virtual volume that uses the same own port as the LUN #0 uses as a priority path, out of the virtual volumes searched at Step S51. Specifically, the path switching controller 130 refers to the volume management table 111 corresponding to the LUN #0, and identifies an own port included in the priority path, from the item of “own port” included in the priority path information. The path switching controller 130 identifies the volume management table 111 in which the own port included in the priority path is the same as the identified own port, out of the volume management tables 111 identified at Step S51. The path switching controller 130 outputs a virtual volume corresponding to the identified volume management table 111, as a search result.

If the corresponded virtual volume is present, the path switching controller 130 executes the process at Step S54, and executes the process at Step S61 in FIG. 12 if not present.

[Step S54] The path switching controller 130 searches a virtual volume that uses the same own port as the LUN #0 uses as a priority path, out of the other virtual volumes other than the LUN #0. Specifically, the path switching controller 130 acquires the own port that is included in the priority path set to the LUN #0 and identified at Step S53. The path switching controller 130 identifies the volume management table 111 in which the own port included in the priority path is the same as the acquired own port, out of the volume management tables 111 respectively corresponding to the other virtual volumes.

The path switching controller 130 sets I1 obtained by adding “1” to the number of the identified volume management tables 111. This I1 indicates the total number of virtual volumes included in the switching range R4. Meanwhile, the path switching controller 130 sets the number of virtual volumes searched at Step S53 to I2. This I2 indicates the number of virtual volumes in which an error due to the volume abnormality occurs, out of the virtual volumes included in the switching range R4.

The path switching controller 130 determines whether I2/I1 is a predetermined ratio or more (for example, half or more). The path switching controller 130 executes the process at Step S55 if I2/I1 is the predetermined ratio or more, and executes the process at Step S61 in FIG. 12 if I2/I1 is less than the predetermined ratio.

[Step S55] The path switching controller 130 updates the corresponding volume management table 111, for all the other virtual volumes that each use the same own port as the LUN #0 uses as a priority path and are identified at Step S54, as follows. Noted that the volume management table 111 as a update target is the volume management table 111 identified at Step S54.

The path switching controller 130 updates the path status so as to indicate the alternate path being in use, and switches the access path to be used to the alternate path. Noted that when the alternate path is already used, the registration information on the path status is maintained without any change. Moreover, the path switching controller 130 updates the registration information on the error factor to “volume abnormality”, and updates the registration information on the switching range to “R4”. Noted that when an error due to the volume abnormality is already detected, the registration information on the error factor is maintained without any change.

With this processing at Step S55, the access path is switched to the alternate path, for all the other virtual volumes that each use the same own port as the LUN #0 uses as a priority path. Accordingly, in the access to the external storage device in response to an access request to each of the virtual volumes, no error due to the volume abnormality is detected. Therefore, an additional access to an external volume is omitted, as a result, it is possible to decrease the number of accesses to the external storage device as a whole.

Hereinafter, the explanation is continued using FIG. 12.

[Step S61] The path switching controller 130 searches a virtual volume that uses the same counterpart port as the LUN #0 uses as a priority path, out of the virtual volumes searched at Step S51. Specifically, the path switching controller 130 refers to the volume management table 111 corresponding to the LUN #0, and identifies a counterpart port included in the priority path, from the item of “counterpart port” included in the priority path information. The path switching controller 130 identifies the volume management table 111 in which the counterpart port included in the priority path is the same as the identified counterpart port, out of the volume management tables 111 identified at Step S51. The path switching controller 130 outputs a virtual volume corresponding to the identified volume management table 111, as a search result.

If the corresponded virtual volume is present, the path switching controller 130 executes the process at Step S62, and executes the process at Step S65 if not present.

[Step S62] The path switching controller 130 searches a virtual volume that uses the same counterpart port as the LUN #0 uses as a priority path, out of the other virtual volumes other than the LUN #0. Specifically, the path switching controller 130 acquires the counterpart port that is included in the priority path set to the LUN #0 and identified at Step S61. The path switching controller 130 identifies the volume management table 111 in which the counterpart port included in the priority path is the same as the acquired counterpart port, out of the volume management tables 111 respectively corresponding to the other virtual volumes. This identifies the virtual volume other than the LUN #0, included in the switching range R3.

Moreover, the path switching controller 130 identifies a virtual volume in which the access path is already switched as the virtual volume included in the switching range R4, out of the identified virtual volumes. Specifically, the path switching controller 130 identifies a virtual volume in which “R4” is registered in the item of the switching range of the corresponding volume management table 111, out of the identified virtual volumes.

The path switching controller 130 excludes the identified already-switched virtual volumes, out of the virtual volumes that are included in the switching range R3 and include the LUN #0, and sets the total number of virtual volumes after the exclusion to J1. Together with this process, the path switching controller 130 excludes the identified already-switched virtual volume also out of the virtual volumes identified at Step S61, and sets 32 obtained by adding 1 to the total number of virtual volumes after the exclusion. This 32 indicates the number of virtual volumes in which an error due to the volume abnormality is detected, out of the 31 pieces of virtual volumes.

[Step S63] The path switching controller 130 determines whether the number of virtual volumes in which an error due to the volume abnormality is detected is a predetermined ratio or more (for example, half or more) relative to the total number of virtual volumes after the exclusion. Specifically, the path switching controller 130 determines whether J2/J1 is a predetermined ratio or more. The path switching controller 130 executes the process at Step S64 if J2/J1 is the predetermined ratio or more, and executes the process at Step S65 if J2/J1 is less than the predetermined ratio.

[Step S64] The path switching controller 130 updates the corresponding volume management table 111 as follows, for all the virtual volumes excluding the already-switched virtual volumes identified at Step S62, out of the other virtual volumes that are included in the switching range R3 and other than the LUN #0.

The path switching controller 130 updates the path status so as to indicate the alternate path being in use, and switches the access path to be used to the alternate path. Noted that when the alternate path is already used, the registration information on the path status is maintained without any change. Moreover, the path switching controller 130 updates the registration information on the error factor to “volume abnormality”, and updates the registration information on the switching range to “R3”. Noted that when an error due to the volume abnormality is already detected, the registration information on the error factor is maintained without any change.

With this processing at Step S64, the access path is switched to the alternate path, for all the virtual volumes that are not included in the switching range R4, out of the other virtual volumes that each use the same counterpart port as the LUN #0 uses as a priority path. Accordingly, in the access to the external storage device in response to an access request to each of the virtual volumes, no error due to the volume abnormality is detected. Therefore, an additional access to an external volume is omitted, as a result, it is possible to decrease the whole number of accesses to the external storage device.

[Step S65] The path switching controller 130 searches a virtual volume that belongs to the same RAID group as the LUN #0, out of the virtual volumes searched at Step S51. Specifically, the path switching controller 130 refers to the volume management table 111 corresponding to the LUN #0, and identifies a RAID group to which the LUN #0 belongs from the item of “RAID group ID”. The path switching controller 130 identifies the volume management table 111 in which the ID of the identified RAID group is registered as a RAID group ID, out of the volume management tables 111 identified at Step S51. The path switching controller 130 outputs a virtual volume corresponding to the identified volume management table 111, as a search result.

If a corresponded virtual volume is present, the path switching controller 130 executes the process at Step S66, and ends the processing if not present.

[Step S66] The path switching controller 130 searches a virtual volume that belongs to the same RAID group as the LUN #0, out of the other virtual volumes other than the LUN #0. Specifically, the path switching controller 130 acquires the RAID group identified at Step S65 to which the LUN #0 belongs. The path switching controller 130 identifies the volume management table 111 in which the ID of the acquired RAID group is registered as a RAID group ID, out of the volume management tables 111 respectively corresponding to the other virtual volumes. This identifies the virtual volumes other than the LUN #0, included in the switching range R2.

Moreover, the path switching controller 130 identifies a virtual volume in which the access path is already switched as the virtual volume included in the switching range R3 or R4, out of the identified virtual volumes. Specifically, the path switching controller 130 identifies a virtual volume in which either one of “R3” and “R4” is registered in the item of the switching range of the corresponding volume management table 111, out of the identified virtual volumes.

The path switching controller 130 excludes the identified already-switched virtual volumes, out of the virtual volumes that are included in the switching range R2 and include the LUN #0, and sets the total number of virtual volumes after the exclusion to K1. Together with this process, the path switching controller 130 excludes the identified already-switched virtual volumes also out of the virtual volumes identified at Step S65, and sets K2 obtained by adding 1 to the total number of virtual volumes after the exclusion. This K2 indicates the number of virtual volumes in which an error due to the volume abnormality is detected, out of the K1 pieces of virtual volumes.

[Step S67] The path switching controller 130 determines whether the number of virtual volumes in which an error due to the volume abnormality is detected is a predetermined ratio or more (for example, half or more) relative to the total number of virtual volumes after the exclusion. Specifically, the path switching controller 130 determines whether K2/K1 is a predetermined ratio or more. The path switching controller 130 executes the process at Step S68 if K2/K1 is the predetermined ratio or more, and ends the processing if K2/K1 is less than the predetermined ratio.

[Step S68] The path switching controller 130 updates the corresponding volume management table 111 as follows, for all the virtual volumes excluding the already-switched virtual volumes identified at Step S66, out of the other virtual volumes that are included in the switching range R2 and other than the LUN #0.

The path switching controller 130 updates the path status so as to indicate the alternate path being in use, and switches the access path to be used to the alternate path. Noted that when the alternate path has been already used, the registration information on the path status is maintained without any change. Moreover, the path switching controller 130 updates the registration information on the error factor to “volume abnormality”, and updates the registration information on the switching range to “R2”. Noted that when an error due to the volume abnormality is already detected, the registration information on the error factor is maintained without any change.

With this processing at Step S68, the access path is switched to the alternate path, for all the virtual volumes that are neither included in the switching ranges R3 nor R4, out of the other virtual volumes that belong to the same RAID group as the LUN #0. Accordingly, in the access to the external storage device in response to an access request to each of the virtual volumes, no error due to the volume abnormality is detected. Therefore, an additional access to an external volume is omitted, as a result, it is possible to decrease the whole number of accesses to the external storage device.

Noted that in FIGS. 11 and 12 described above, the priority is assigned in the order of the switching ranges R4, R3, and R2, and the determination of the switching range is made in decreasing order of priority. In this example, used is the concept in which using the setting item related to the hardware closer to the storage device 100, as an extraction condition for identifying the switching range, has a possibility of allow the switching range to include virtual volumes of the wider range, and has a large degree of influence. Based on this concept, when virtual volumes previously included in the switching range R4 are determined as targets of path switching, these virtual volumes are controlled so as to be included in neither the switching range R2 nor R3. Moreover, when virtual volumes previously included in either one of the switching ranges R3 and R4 are determined as targets of path switching, these virtual volumes are controlled so as not to be included in the switching range R2. This allows the switching range to be appropriately set.

Next, based on the configuration illustrated in FIG. 4, an execution example of actual path switching is described.

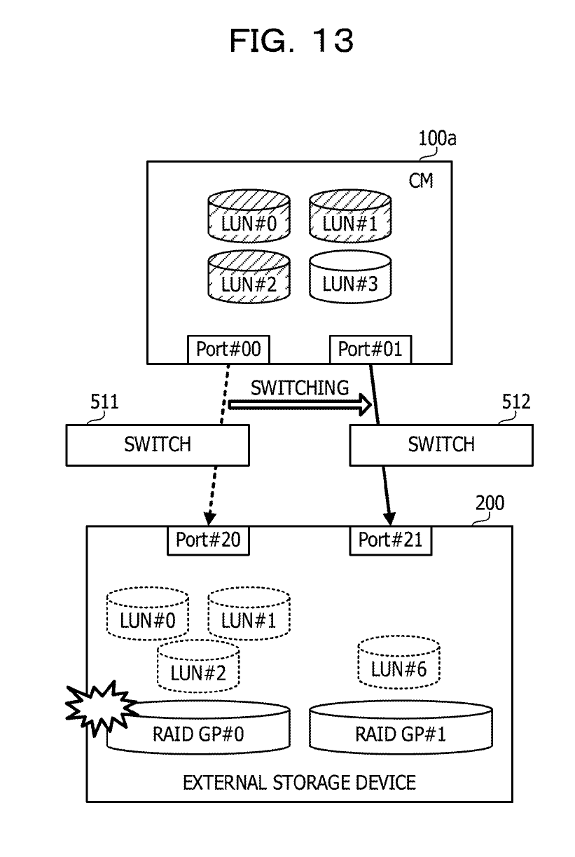

FIG. 13 is a diagram illustrating an example of a case where the path switching is performed with respect to virtual volumes that belong to the same RAID group. In FIG. 13, it is assumed that an error due to the volume abnormality is detected in the access to the external storage device 200 in response to an access request to the LUN #0. Moreover, the ports #00 and #20 are set as priority ports of the LUN #0, and the ports #01 and #21 are set as the alternate ports of the LUN #0.

The host IO controller 120 switches the access path of the LUN #0 from the path that passes through the ports #00 and #20 to the path that passes through the ports #01 and #21. Moreover, the path switching controller 130 identifies the LUNs #1 and #2 as other virtual volumes that belong to the RAID group #0, similar to the LUN #0. Here, when an error due to the volume abnormality has been detected in the virtual volumes of the predetermined ratio in the LUNs #0 to #2, the path switching controller 130 switches the access path also in the LUNs #1 and #2. In FIG. 13, the priority port and alternate port similar to those in the LUN #0 are set also in the LUNs #1 and #2. In this case, the path switching controller 130 switches the access paths of the LUNs #1 and #2 from the path that passes through the ports #00 and #20 to the path that passes through the ports #01 and #21.

In this case, for example, it is highly probably that a fault occurs in at least one disk allocated to the RAID group #0 or the IO control of the RAID group #0 executed by the CM 210. Therefore, the path switching is performed with respect to all the virtual volumes that belong to the RAID group #0, so that it is possible to perform the path switching only with respect to the virtual volumes of the minimum range while the occurrence of an error is reliably reduced in these virtual volumes.

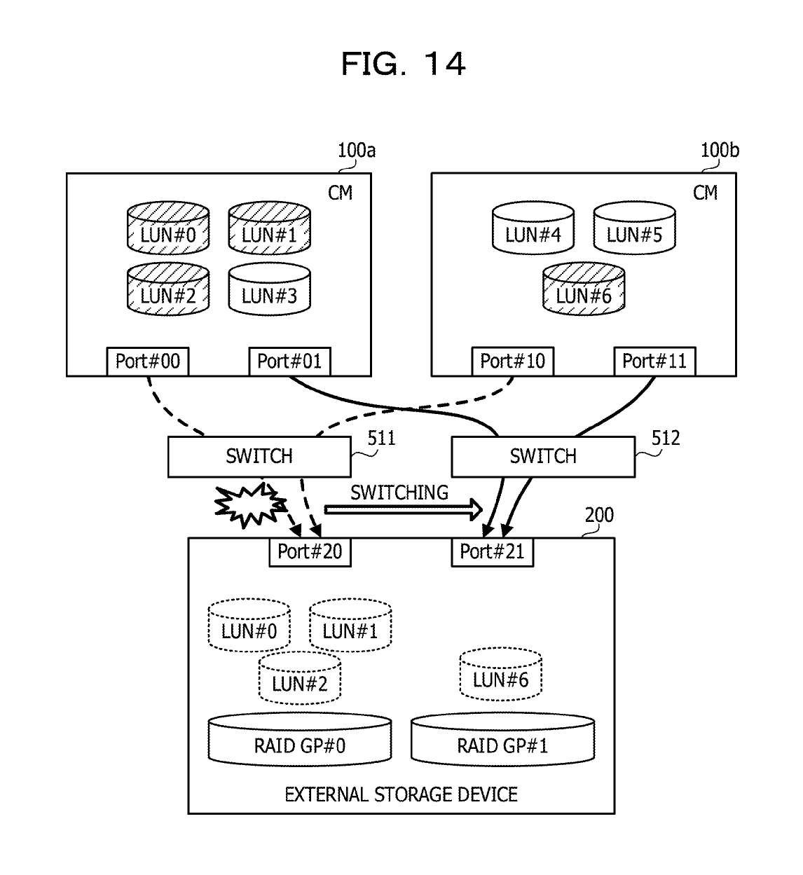

FIG. 14 is a diagram illustrating an example of a case where the path switching is performed with respect to virtual volumes that use the same counterpart port. Also in FIG. 14, similar to FIG. 13, it is assumed that an error due to the volume abnormality is detected in the access to the external storage device 200 in response to an access request to the LUN #0. Accordingly, the host IO controller 120 switches the access path of the LUN #0 from the path that passes through the ports #00 and #20 to the path that passes through the ports #01 and #21.

Moreover, the path switching controller 130 identifies the LUNs #1, #2, and #6 in which the counterpart port included in the priority path is the port #20, similar to the LUN #0. Here, when an error due to the volume abnormality has been detected in the virtual volumes of the predetermined ratio in the LUNs #0 to #2, #6, the path switching controller 130 switches the access paths also in the LUNs #1, #2, and #6. Specifically, the path switching controller 130 switches the access paths of the LUNs #1 and #2 to the path that passes through the ports #01 and #21. Moreover, the path switching controller 130 switches the access path of the LUN #6 to the path that passes through the ports #11 and #21.

In this case, for example, it is highly probably that a fault occurs on a route from the switch 511 to the port #20. Therefore, the path switching is performed with respect to all the virtual volumes in which the priority path includes the port #20, so that it is possible to perform the path switching only with respect to the virtual volumes of the minimum range while the occurrence of an error is reliably reduced in these virtual volumes.

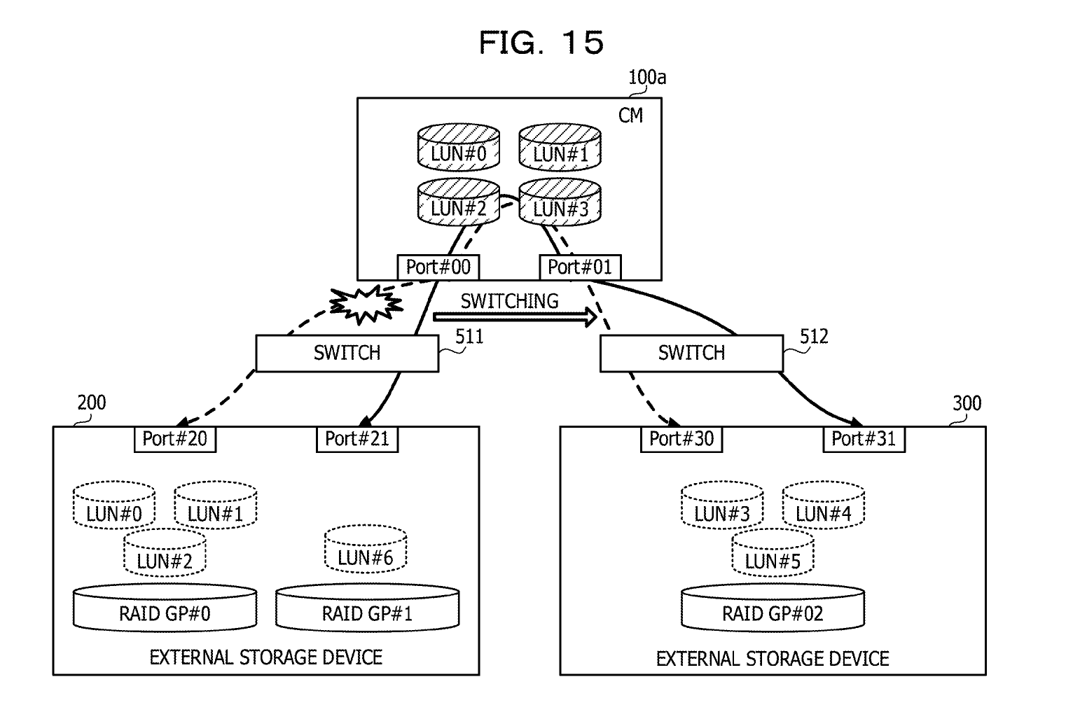

FIG. 15 is a diagram illustrating an example of a case where the path switching is performed with respect to virtual volumes that use the same own port. Also in FIG. 15, similar to FIGS. 13 and 14, it is assumed that an error due to the volume abnormality is detected in the access to the external storage device 200 in response to an access request to the LUN #0. Accordingly, the host IO controller 120 switches the access path of the LUN #0 from the path that passes through the ports #00 and #20 to the path that passes through the ports #01 and #21.

Moreover, the path switching controller 130 identifies LUNs #1 to #3 in which the own port included in the priority path is the port #00, similar to the LUN #0. Here, when an error due to the volume abnormality has been detected in the virtual volumes of the predetermined ratio in the LUNs #0 to #3, the path switching controller 130 switches the access paths also in the LUNs #1 to #3. Specifically, the path switching controller 130 switches the access paths of the LUNs #1 and #2 to the path that passes through the ports #01 and #21. Moreover, the path switching controller 130 switches the access path of the LUN #3 to the path that passes through the ports #01 and #31.

In this case, for example, it is highly probably that a fault occurs on a route from the switch 511 to the port #00. Therefore, the path switching is performed with respect to all the virtual volumes in which the priority path includes the port #00, so that it is possible to perform the path switching only with respect to the virtual volume of minimum range while the occurrence of an error is reliably reduced in these virtual volumes.

Noted that the processing function of each of the devices (for example, the storage control device 1, the CMs 100a, 100b, 210, and 310) indicated in the respective embodiments may be implemented by a computer. In that case, a program in which the process content of a function that each device includes is described is provided, and the program is executed by the computer, thereby implementing the abovementioned process function on the computer. It is possible to record the program in which the process content is described on a computer-readable recording medium. Examples of the computer-readable recording medium includes a magnetic memory device, an optical disk, an optical magnetic recording medium, and a semiconductor memory. Examples of the magnetic memory device includes a hard disk drive (HDD), a flexible disk (FD), and magnetic tape. Examples of the optical disk include a digital versatile disc (DVD), a DVD-RAM, a compact disc-read only memory (CD-ROM), and a CD recordable (CD-R)/a CD rewritable (CD-RW). Examples of the optical magnetic recording medium include a magneto-optical disk (MO).

When a program is distributed, for example, transportable recording media, such as the DVD or the CD-ROM on which the program is record are on the market. Moreover, it is also possible to store a program in a memory device of a server computer, and transfer the program to other computers from the server computer via a network.

A computer that executes a program stores, for example, a program that is recorded on the computer transportable recording medium or a program that is transferred from the server computer, in an own memory device. Further, the computer reads the program from the own memory device, and executes the process in accordance with the program. Noted that the computer is also able to directly read a program from the transportable recording medium, and execute the process in accordance with the program. Moreover, every time when a program is transferred to a computer from the server coupled thereto via the network, the computer may successively execute the process in accordance with the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device configured to access a storage device via a plurality of access paths, a plurality of virtual volumes being formed using the storage device, the storage control device comprising:
a memory configured to store setting information on each of the plurality of virtual volumes, the setting information including respective setting values of a plurality of setting items, the plurality of setting items including a path setting item that identifies a specific path included in the plurality of access paths used when the storage control device accesses the storage device; and
a processor coupled to the memory and configured to:
when a communication error is detected in an accessing from the storage control device to the storage device, store error detection information indicating that the communication error is detected in the accessing;
receive an access request to a first virtual volume included in the plurality of virtual volumes;
in response to the access request, access the first virtual volume via a first access path as the specific path identified based on the setting values of the path setting items;
when a communication error is detected in an accessing to the first virtual volume, access the first virtual volume by using a second access path included in the plurality of access paths;
based on the setting information, generate a plurality of virtual volume groups from the plurality of virtual volumes;
based on the error detection information, select a first virtual volume group from the plurality of virtual volume groups, the setting values of a plurality of virtual volumes included in the first virtual volume group having certain relationship to the setting items of the first virtual volume; and
modify the specific path for a second virtual volume in which no communication error is detected and which is included in the first virtual volume group.

2. The storage control device according to claim 1, wherein
the processor is configured to generate the plurality of virtual volume groups by executing a first process, a second process, and a third process with respect to each of the plurality of setting items of the setting information,
the first process is a process that uses at least one setting item of the plurality of setting items as a selection setting item,
the second process is a process to specify a plurality of second virtual volumes of the plurality of virtual volumes in which the setting values of the selection setting items match the setting values of the selection setting item in the first virtual volume, and
the third process is a process to set the virtual volume groups that include the plurality of second virtual volumes specified in the second process.

3. The storage control device according to claim 2, wherein
the processor is configured to:
specify a number of virtual volumes included in a virtual volume group in which the communication error occurs, for each of the plurality of virtual volume groups; and
select the first virtual volume group based on the number of virtual volumes.

4. The storage control device according to claim 3, wherein
the number of virtual volumes is a certain value or more, or a ratio of the number relative to a total number of the virtual volumes included in the identified virtual volume group is a certain ratio or more.

5. The storage control device according to claim 2, wherein
the plurality of setting items include a plurality of the path setting items, and
the plurality of path setting items are selected as the selection setting items in the first process.

6. The storage control device according to claim 2, wherein
the plurality of setting items include a redundant array of inexpensive disks (RAID) setting item indicating a RAID group to which each of the plurality of virtual volumes belongs, and
the RAID setting item is selected as the selection setting item in the first process.

7. The storage control device according to claim 1, wherein
the communication error is a retry out of the access request to the storage device.

8. The storage control device according to claim 4, wherein
the processor is configured to:
select each of the plurality of virtual volume groups in a selection order, in selecting of the first virtual volume group;
select the first virtual volume group by determining whether the communication error is detected in the virtual volumes of the certain ratio or more in the second virtual volumes; and
set the first virtual volume group that is identified in accordance with the selection order as a switching target of the specific path.

9. A method using a storage control device configured to access a storage device via a plurality of access paths, a plurality of virtual volumes being formed using the storage device, the method comprising:
obtaining setting information on each of the plurality of virtual volumes, the setting information including respective setting values of a plurality of setting items, the plurality of setting items including a path setting item that identifies a specific path included in the plurality of access paths used when the storage control device accesses the storage device;
when a communication error is detected in an accessing from the storage control device to the storage device, storing error detection information indicating that the communication error is detected in the accessing;
receiving an access request to a first virtual volume included in the plurality of virtual volumes;
in response to the access request, accessing the first virtual volume via a first access path as the specific path identified based on the setting values of the path setting items;
when a communication error is detected in an accessing to the first virtual volume, accessing the first virtual volume by using a second access path included in the plurality of access paths;
based on the setting information, generating a plurality of virtual volume groups from the plurality of virtual volumes;
based on the error detection information, selecting a first virtual volume group from the plurality of virtual volume groups, the setting values of a plurality of virtual volumes included in the first virtual volume group having certain relationship to the setting items of the first virtual volume; and
modifying the specific path for a second virtual volume in which no communication error is detected and which is included in the first virtual volume group.

10. The method according to claim 9, wherein
the generating of the plurality of virtual volume groups includes a first process, a second process, and a third process with respect to each of the plurality of setting items of the setting information,
the first process is a process that uses at least one setting item of the plurality of setting items as a selection setting item,
the second process is a process to specify a plurality of second virtual volumes of the plurality of virtual volumes in which the setting values of the selection setting items match the setting values of the selection setting item in the first virtual volume, and
the third process is a process to set the virtual volume groups that include the plurality of second virtual volumes specified in the second process.

11. The method according to claim 10, further comprising:
specifying a number of virtual volumes included in a virtual volume group in which the communication error occurs, for each of the plurality of virtual volume groups; and
selecting the first virtual volume group based on the number of virtual volumes.

12. The method according to claim 11, wherein
the number of virtual volumes is a certain value or more, or a ratio of the number relative to a total number of the virtual volumes included in the identified virtual volume group is a certain ratio or more.

13. The method according to claim 10, wherein
the plurality of setting items include a plurality of the path setting items, and
the plurality of path setting items are selected as the selection setting items in the first process.

14. The method according to claim 10, wherein
the plurality of setting items include a redundant array of inexpensive disks (RAID) setting item indicating a RAID group to which each of the plurality of virtual volumes belongs, and
the RAID setting item is selected as the selection setting item in the first process.

15. The method according to claim 9, wherein
the communication error is a retry out of the access request to the storage device.

16. The method according to claim 12, further comprising:
selecting each of the plurality of virtual volume groups in a selection order, in selecting of the first virtual volume group;
selecting the first virtual volume group by determining whether the communication error is detected in the virtual volumes of the certain ratio or more in the second virtual volumes; and
setting the first virtual volume group that is identified in accordance with the selection order as a switching target of the specific path.

17. A non-transitory computer-readable storage medium storing a program that causes an information processing apparatus to execute a process, the process comprising:
obtaining setting information on each of the plurality of virtual volumes, the setting information including respective setting values of a plurality of setting items, the plurality of setting items including a path setting item that identifies a specific path included in the plurality of access paths used when the storage control device accesses the storage device;
when a communication error is detected in an accessing from the storage control device to the storage device, storing error detection information indicating that the communication error is detected in the accessing;
receiving an access request to a first virtual volume included in the plurality of virtual volumes;
in response to the access request, accessing the first virtual volume via a first access path as the specific path identified based on the setting values of the path setting items;
when a communication error is detected in an accessing to the first virtual volume, accessing the first virtual volume by using a second access path included in the plurality of access paths;
based on the setting information, generating a plurality of virtual volume groups from the plurality of virtual volumes;
based on the error detection information, selecting a first virtual volume group from the plurality of virtual volume groups, the setting values of a plurality of virtual volumes included in the first virtual volume group having certain relationship to the setting items of the first virtual volume; and
modifying the specific path for a second virtual volume in which no communication error is detected and which is included in the first virtual volume group.

18. The non-transitory computer-readable storage medium according to claim 17, wherein
the generating of the plurality of virtual volume groups includes a first process, a second process, and a third process with respect to each of the plurality of setting items of the setting information,
the first process is a process that uses at least one setting item of the plurality of setting items as a selection setting item,
the second process is a process to specify a plurality of second virtual volumes of the plurality of virtual volumes in which the setting values of the selection setting items match the setting values of the selection setting item in the first virtual volume, and
the third process is a process to set the virtual volume groups that include the plurality of second virtual volumes specified in the second process.

19. The non-transitory computer-readable storage medium according to claim 18, the process further comprising:
specifying a number of virtual volumes included in a virtual volume group in which the communication error occurs, for each of the plurality of virtual volume groups; and
selecting the first virtual volume group based on the number of virtual volumes.

20. The non-transitory computer-readable storage medium according to claim 19, wherein
the number of virtual volumes is a certain value or more, or a ratio of the number relative to a total number of the virtual volumes included in the identified virtual volume group is a certain ratio or more.
